(19) United States
(12) Patent Application Publication
(10) Pub. No.: US 2025/0227699 A1
(43) Pub. Date: Jul. 10, 2025

(54) METHOD AND DEVICE FOR TRANSMITTING/RECEIVING SIGNALS IN WIRELESS COMMUNICATION SYSTEM

(71) Applicant: LG ELECTRONICS INC., Seoul (KR)

(72) Inventors: Seunghwan CHOI, Seoul (KR); Suckchel YANG, Seoul (KR); Seonwook KIM, Seoul (KR); Youngdae LEE, Seoul (KR); Seungjin AHN, Seoul (KR)

(73) Assignee: LG ELECTRONICS INC., Seoul (KR)

(21) Appl. No.: 18/850,940

(22) PCT Filed: Apr. 28, 2023
(86) PCT No.: PCT/KR2023/005873

§ 371 Date: Sep. 25, 2024

Related U.S. Application Data
(60) Provisional application No. 63/336,271, filed on Apr. 28, 2022.

(30) Foreign Application Priority Data
Aug. 11, 2022 (KR) 10-2022-0100872
Nov. 4, 2022 (KR) 10-2022-0146511
Feb. 16, 2023 (KR) 10-2023-0021061

(51) Int. Cl. H04W 72/1273; H04W 72/0446; H04W 72/231

(52) U.S. Cl. CPC H04W 72/1273; H04W 72/0446; H04W 72/231

(57) ABSTRACT

A method and a device for transmitting/receiving signals in a wireless communication system, disclosed in the present specification, comprise receiving DCI for scheduling PDSCHs or PUSCHs in different cells. Specifically, the DCI includes one or more TDRA fields for the PDSCHs or the PUSCHs in the different cells.

### CROSS-REFERENCE TO RELATED APPLICATIONS

This application is the National Stage filing under 35 U.S.C. 371 of International Application No. PCT/KR2023/005873, filed on Apr. 28, 2023, which claims the benefit of earlier filing date and right of priority to Korean Application Nos. 10-2022-0100872, filed on Aug. 11, 2022, 10-2022-0146511, filed on Nov. 4, 2022, and 10-2023-0021061, filed on Feb. 16, 2023, and also claims the benefit of U.S. Provisional Application No. 63/336,271, filed on Apr. 28, 2022, the contents of which are all hereby incorporated by reference herein in their entireties.

### TECHNICAL FIELD

The present disclosure relates to a method and apparatus for use in a wireless communication system.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of code division multiple access (CDMA) system, frequency division multiple access (FDMA) system, time division multiple access (TDMA) system, orthogonal frequency division multiple access (OFDMA) system, single carrier frequency division multiple access (SC-FDMA) system, and the like.

### SUMMARY

The object of the present disclosure is to provide a signal transmission and reception method for efficiently transmitting and receiving control and data signals in a wireless communication system and apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

The present disclosure provides a method and apparatus for transmitting and receiving a signal in a wireless communication system.

According to an aspect of the present disclosure, a method of transmitting and receiving a signal by a user equipment (UE) in a wireless communication system includes receiving downlink control information (DCI) for scheduling physical downlink shared channels (PDSCHs) or physical uplink shared channels (PUSCHs) on different cells, and receiving the PDSCHs on the different cells or transmitting the PUSCHs on the different cells based on the DCI, wherein the DCI includes one or more time domain resource assignment (TDRA) for the PDSCHs or the PUSCH on the different cells.

According to another aspect of the present disclosure, a method of transmitting and receiving a signal by a base station (BS) in a wireless communication system includes transmitting downlink control information (DCI) for scheduling physical downlink shared channels (PDSCHs) or physical uplink shared channels (PUSCHs) on different cells, and transmitting the PDSCHs on the different cells or receiving the PUSCHs on the different cells based on the DCI, wherein the DCI includes one or more time domain resource assignment (TDRA) for the PDSCHs or the PUSCH on the different cells.

In another aspect of the present disclosure, there are provided an apparatus, a processor, and a storage medium for performing the signal transmission and reception method.

The apparatus may include an autonomous driving vehicle communicable with at least a UE, a network, and another autonomous driving vehicle other than the communication apparatus.

The above-described aspects of the present disclosure are only some of the preferred embodiments of the present disclosure, and various embodiments reflecting the technical features of the present disclosure may be derived and understood from the following detailed description of the present disclosure by those skilled in the art.

According to one embodiment of the present disclosure, when control and data signals are transmitted and received between communication devices, the signals may be transmitted and received more efficiently based on operations different from those in the prior art

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates a radio frame structure.

FIG. 2 illustrates a resource grid during the duration of a slot.

FIG. 3 illustrates a self-contained slot structure.

FIG. 4 illustrates an acknowledgment/negative acknowledgment (ACK/NACK) transmission process.

FIG. 5 illustrates a physical uplink shared channel (PUSCH) transmission process.

FIGS. 6 to 7 are diagrams illustrating uplink (UL) channel transmission according to the embodiments of the present disclosure.

FIGS. 8 to 11 illustrate devices according to an embodiment of the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

For clarity of description, the present disclosure will be described in the context of a 3GPP communication system (e.g., LTE and NR), which should not be construed as limiting the spirit of the present disclosure. LTE refers to a technology beyond 3GPP TS 36.xxx Release 8. Specifically, the LTE technology beyond 3GPP TS 36.xxx Release 10 is called LTE-A, and the LTE technology beyond 3GPP TS 36.xxx Release 13 is called LTE-A pro. 3GPP NR is the technology beyond 3GPP TS 38.xxx Release 15. LTE/NR may be referred to as a 3GPP system. “xxx” specifies a technical specification number. LTE/NR may be generically referred to as a 3GPP system. For the background technology, terminologies, abbreviations, and so on as used herein, refer to technical specifications published before the present disclosure. For example, the following documents may be referred to.

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

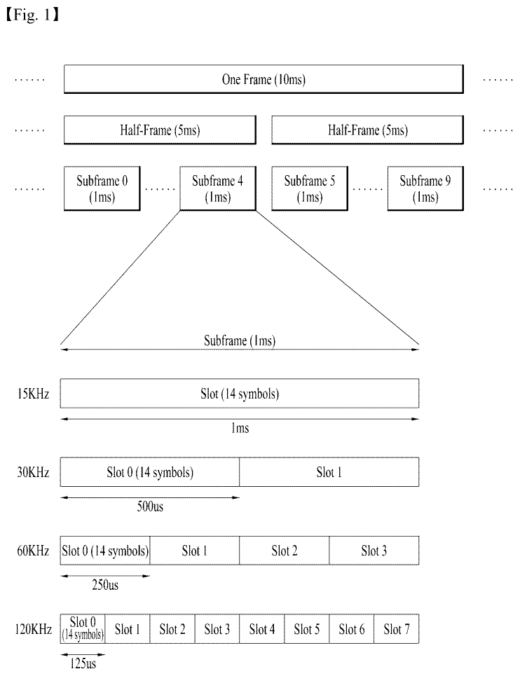

FIG. 1 illustrates a radio frame structure used for NR.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM(A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: number of symbols in a slot
*N^{frame, u}ₛₗₒₜ: number of slots in a frame
*N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding frequency | |
|---|---|---|
| designation | range | Subcarrier Spacing |
| FR1 | 450 MHz-7125 MHz | 15, 30, 60 kHz |
| FR2 | 24250 MHz-52600 MHz | 60, 120, 240 kHz |

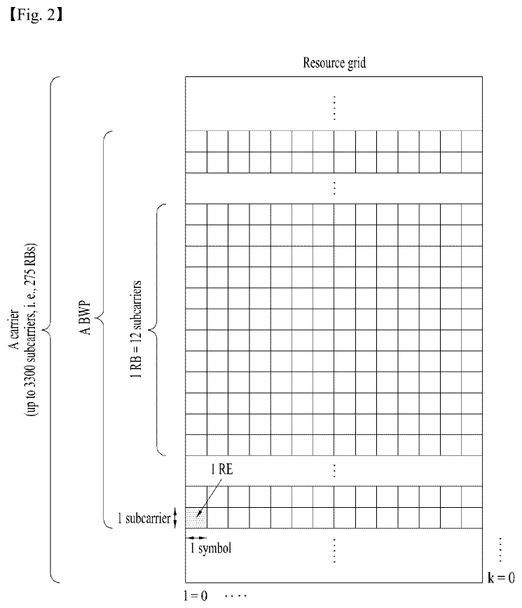

FIG. 2 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A plurality of RB interlaces (simply, interlaces) may be defined in the frequency domain. Interlace mϵ{0, 1, . . . , M−1} may be composed of (common) RBs {m, M+m, 2M+m, 3M+m, . . . }. M denotes the number of interlaces. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

In a wireless communication system, a UE receives information from a BS in downlink (DL), and the UE transmits information to the BS in uplink (UL). The information exchanged between the BS and UE includes data and various control information, and various physical channels/signals are present depending on the type/usage of the information exchanged therebetween. A physical channel corresponds to a set of resource elements (REs) carrying information originating from higher layers. A physical signal corresponds to a set of REs used by physical layers but does not carry information originating from the higher layers. The higher layers include a medium access control (MAC) layer, a radio link control (RLC) layer, a packet data convergence protocol (PDCP) layer, a radio resource control (RRC) layer, and so on.

DL physical channels include a physical broadcast channel (PBCH), a physical downlink shared channel (PDSCH), and a physical downlink control channel (PDCCH). DL physical signals include a DL reference signal (RS), a primary synchronization signal (PSS), and a secondary synchronization signal (SSS). The DL RS includes a demodulation reference signal (DM-RS), a phase tracking reference signal (PT-RS), and a channel state information reference signal (CSI-RS). UL physical channel include a physical random access channel (PRACH), a physical uplink shared channel (PUSCH), and a physical uplink control channel (PUCCH). UL physical signals include a UL RS. The UL RS includes a DM-RS, a PT-RS, and a sounding reference signal (SRS).

FIG. 3 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.

In the present disclosure, a base station (BS) may be, for example, a gNode B (gNB).

### DL Physical Channel/Signal

### (1) PDSCH

A PDSCH carries DL data (e.g., DL-shared channel transport block (DL-SCH TB)). The TB is coded into a codeword (CW) and then transmitted after scrambling and modulation processes. The CW includes one or more code blocks (CBs). One or more CBs may be grouped into one code block group (CBG). Depending on the configuration of a cell, the PDSCH may carry up to two CWs. Scrambling and modulation may be performed for each CW, and modulation symbols generated from each CW may be mapped to one or more layers. Each layer may be mapped to resources together with a DMRS after precoding and transmitted on a corresponding antenna port. The PDSCH may be dynamically scheduled by a PDCCH (dynamic scheduling). Alternatively, the PDSCH may be semi-statically scheduled based on higher layer (e.g., RRC) signaling (and/or Layer 1 (L1) signaling (e.g., PDCCH)) (configured scheduling (CS)). Therefore, in the dynamic scheduling, PDSCH transmission is accompanied by the PDCCH, whereas in the CS, PDSCH transmission may not be accompanied by the PDCCH. The CS may include semi-persistent scheduling (SPS).

### (2) PDCCH

A PDCCH carries Downlink Control Information (DCI). For example, the PDCCH (i.e., DCI) may carry: transmission formats and resource allocation of a DL-SCH; frequency/time resource allocation information on an uplink shared channel (UL-SCH); paging information on a paging channel (PCH); system information on a DL-SCH; time/frequency resource allocation information on a higher layer control message such as a random access response (RAR) transmitted over a PDSCH; transmit power control commands; and information on activation/deactivation of SPS/CS. Various DCI formats may be provided depending on information in DCI.

Table 4 shows DCI formats transmitted over the PDCCH.

TABLE 4

| DCI format | Usage |
|---|---|
| 0_0 | Scheduling of PUSCH in one cell |
| 0_1 | Scheduling of one or multiple PUSCH in one cell, or indicating downlink |
| | feedback information for configured grant PUSCH (CG-DFI) |
| 1_0 | Scheduling of PDSCH in one cell |
| 1_1 | Scheduling of PDSCH in one cell, and/or triggering one shot HARQ-ACK |
| | codebook feedback |
| 2_0 | Notifying a group of UEs of the slot format, available RB sets, COT duration and |
| | search space set group switching |
| 2_1 | Notifying a group of UEs of the PRB(s) and OFDM symbol(s) where UE may |
| | assume no transmission is intended for the UE |
| 2_2 | Transmission of TPC commands for PUCCH and PUSCH |
| 2_3 | Transmission of a group of TPC commands for SRS transmissions by one or |
| | more UEs |

DCI format 0_0 may be used to schedule a TB-based (or TB-level) PUSCH, and DCI format 0_1 may be used to schedule a TB-based (or TB-level) PUSCH or a CBG-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or UL scheduling information. DCI format 20 may be used to provide dynamic slot format information (e.g., dynamic SFI) to the UE, and DCI format 2_1 may be used to provide downlink pre-emption information to the UE. UEs defined as one group may be provided with DCI format 2_0 and/or DCI format 2_1 over a group common PDCCH, which is a PDCCH defined for a group of UEs.

The PDCCH/DCI may include a cyclic redundancy check (CRC), and the CRC may be masked/scrambled with various identifiers (e.g., radio network temporary identifier (RNTI)) according to the owner or purpose of the PDCCH. For example, if the PDCCH is for a specific UE, the CRC may be masked with a cell-RNTI (C-RNTI). If the PDCCH relates to paging, the CRC may be masked with a paging-RNTI (P-RNTI). If the PDCCH relates to system information (e.g., system information block (SIB)), the CRC may be masked with a system information RNTI (SI-RNTI). If the PDCCH relates to a random access response, the CRC may be masked with a random access-RNTI (RA-RNTI).

Table 5 shows the usage of the PDCCH and transport channels according to the type of RNTI. Here, the transport channel means a transport channel related to data carried by a PDSCH/PUSCH scheduled by the PDCCH.

TABLE 5

| RNTI | Usage | Transport Channel |
|---|---|---|
| P-RNTI | Paging and System Information change notification | PCH(Paging Channel) |
| SI-RNTI | Broadcast of System Information | DL-SCH |
| RA-RNTI | Radom Access Response | DL-SCH |
| Temporary C-RNTI | Contention Resolution | DL-SCH |
| | (when no valid C-ENTI is available) | |
| Temporary C-RNTI | Mag3 transmission | UL-SCH |
| C-RNTI, MCS(Modulation | Dynamically scheduled unicast transmission | UL-SCH |
| and Coding Schame)-C- | | |
| RNTI | | |
| C-RNTI | Dynamically scheduled unicast transmission | DL-SCH |
| MCS-C-RNTI | Dynamically scheduled unicast transmission | DL-SCH |
| C-RNTI | Triggering of PDOCH ordered randoms access | NA |
| CS(Configued Scheduling)- | Configured scheduled wicast transmission | DL-SCH, UL SCH |
| RNTI | (activation, reactivation and retransmission) | |
| CS-RNTI | Configured scheduled unicast transmission | N/A |
| | (deactivation) | |
| TPC(Transmit Power | PUCCH power control | NA |
| Control)-PUCCH-RNTI | | |
| TPC-PUSCH-RNTI | PUSCH power control | NA |
| TPC-SRS-RNTI | SRS trigger and power control | NA |
| INT(Interruption)-ANTI | Inciscation pre-ensution in DE. | |
| SFI(Slot Format Indication)- | Slot Format Indication on the given cell | NA |
| RNTI | | |
| SP(Semi-persistent)- | Activation of Semi-persistent CSI reporting on PUSCH | N/A |
| CSI(Channel State | | |
| Information)-RNTI | | |

For the PDCCH, a fixed modulation scheme may be used (e.g., quadrature phase shift keying (QPSK)). One PDCCH may include 1, 2, 4, 8, or 16 control channel elements (CCEs) depending on the aggregation level (AL). One CCE may include 6 resource element groups (REGs), and one REG may be defined by one OFDMA symbol and one (P)RB.

The PDCCH may be transmitted in a control resource set (CORESET). The CORESET corresponds to a set of physical resources/parameters used to carry the PDCCH/DCI within a BWP. For example, the CORESET may include a set of REGs with a given numerology (e.g., SCS, CP length, etc.). The CORESET may be configured by system information (e.g., MIB) or UE-specific higher layer (e.g., RRC) signaling. For example, the following parameters/information may be used to configure the CORESET. One UE may be configured with one or more CORESETs, and a plurality of CORESETs may overlap in the time/frequency domain.
controlResourceSetId: this parameter/information indicates the identifier (ID) of the CORESET.
frequencyDomainResources: this parameter/information indicates frequency-domain resources of the CORESET. The frequency-domain resources may be indicated by a bitmap, and each bit corresponds to an RB group (=6 consecutive RBs). For example, the most significant bit (MSB) of the bitmap corresponds to the first RB group in the BWP. An RB group corresponding to a bit with a value of 1 may be allocated as a frequency-domain resource of the CORESET.
duration: this parameter/information indicates time-domain resources of the CORESET. The parameter/information duration may indicate the number of consecutive OFDMA symbols included in the CORESET. For example, duration has a value of 1-3.
cce-REG-MappingType: this parameter/information indicates a CCE-to-REG mapping type. An interleaved type and a non-interleaved type may be supported.
precoderGranularity: this parameter/information indicates a precoder granularity in the frequency domain.
tci-StatesPDCCH: this parameter/information indicates information (e.g., TCI-StateID) on a transmission configuration indication (TCI) state for the PDCCH. The TCI state may be used to provide a quasi-co-location (QCL) relationship between DL RS(s) in an RS set (TCI-state) and a PDCCH DMRS port.
tci-PresentInDCI: this parameter/information indicates whether a TCI field is included in DCI.
pdcch-DMRS-ScramblingID: this parameter/information indicates information used for initialization of a PDCCH DMRS scrambling sequence.

For PDCCH reception, the UE may monitor (e.g., blind decoding) a set of PDCCH candidates in the CORESET. The PDCCH candidate may mean CCE(s) monitored by the UE for PDCCH reception/detection. PDCCH monitoring may be performed in one or more CORESETs in an active DL BWP on each active cell in which the PDCCH monitoring is configured. The set of PDCCH candidates monitored by the UE may be defined as a PDCCH search space (SS) set. The SS set may be classified into a common search space (CSS) set or a UE-specific search space (USS) set.

Table 6 shows PDCCH search spaces.

TABLE 6

| Search Space | Type | RNTI | Use Case |
|---|---|---|---|
| Type0-PDCCH | Common | SI-RNTI on a primary cell | Broadcast of System |
| | | | Information. |
| Type0A-PDCCH | Common | SI-RNTI on a primary cell | Broadcast of System |
| | | | Information |
| Type1-PDCCH | Common | RA-RNTI or TC-RNTI on a primary cell | Msg2, Msg4 in RACH |
| Type2-PDCCH | | P-RNTI on a primary cell | Paging |
| | | | System Information |
| | | | change notification |
| Type3-PDCCH | Common | INT-RNTI, SFI-RNTI, TPC-PUSCH-RNTI, TPC- | Group signaling |
| | | PUCCH-RNTI, TPC-SRS-RNTI, C-RNTI, MCS- | |
| | | C-RNTI or CS-RNTI | |
| UE Specific | UE Specific | C-RNTI, MCS-C-RNTI or CS-RNTI | UE signaling (e.g., |
| | | | PDSCH PUSCH) |

The SS set may be configured by system information (e.g., MIB) or UE-specific higher layer (e.g., RRC) signaling. S (e.g., 10) SS sets or less may be configured in each DL BWP of a serving cell. For example, the following parameters/information may be provided for each SS set. Each SS set may be associated with one CORESET, and each CORESET configuration may be associated with one or more SS sets.
searchSpaceId: this parameter/information indicates the ID of the SS set.
controlResourceSetId: this parameter/information indicates the CORESET associated with the SS set.
monitoringSlotPeriodicityAndOffset: this parameter/information indicates a PDCCH monitoring periodicity (in a unit of slot) and a PDCCH monitoring offset (in a unit of slot)
monitoringSymbolsWithinSlot: this parameter/information indicates first OFDMA symbol(s) for PDCCH monitoring in a slot in which the PDCCH monitoring is configured. The first OFDMA symbol(s) are indicated by a bitmap, and each bit corresponds to each OFDMA symbol in the slot. The MSB of the bitmap corresponds to the first OFDM symbol in the slot. OFDMA symbol(s) corresponding to bit(s) with a value of 1 corresponds to the first symbol(s) in the CORESET in the slot.
nrofCandidates: this parameter/information indicates the number of PDCCH candidates (e.g., one of 0, 1, 2, 3, 4, 5, 6, and 8) for each AL (where AL={1, 2, 4, 8, 16}).
searchSpaceType: this parameter/information indicates whether the SS type is the CSS or USS.
DCI format: this parameter/information indicates the DCI format of a PDCCH candidate.

The UE may monitor PDCCH candidates in one or more SS sets in a slot according to the configuration of the CORESET/SS set. An occasion (e.g., time/frequency resource) to monitor PDCCH candidates is defined as a PDCCH (monitoring) occasion. One or more PDCCH (monitoring) occasions may be configured within a slot.

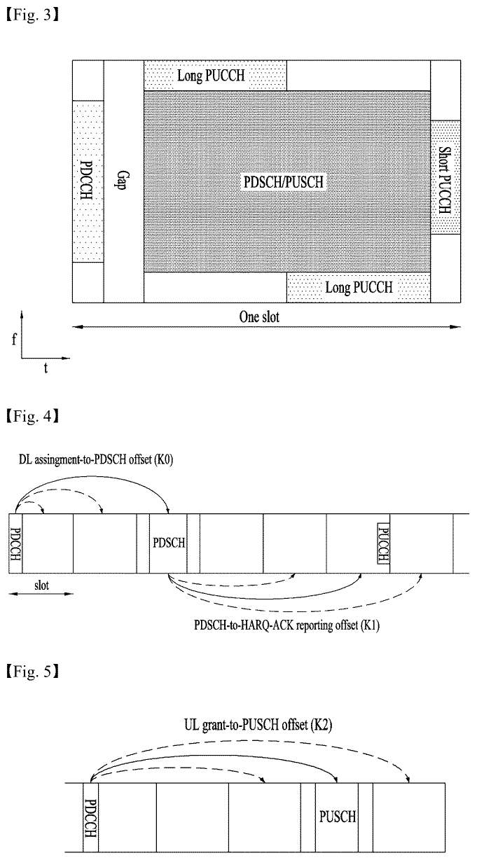

FIG. 4 illustrates an ACK/NACK transmission process.

Referring to FIG. 4, the UE may detect a PDCCH in slot #n. The PDCCH includes DL scheduling information (e.g., DCI format 1_0 or DCI format 11). The PDCCH indicates a DL assignment-to-PDSCH offset, K0 and a PDSCH-to-HARQ-ACK reporting offset, K1. For example, DCI format 1_0 or DCI format 1_1 may include the following information.
Frequency domain resource assignment: Indicates an RB set assigned to a PDSCH.
Time domain resource assignment: Indicates K0 and the starting position (e.g., OFDM symbol index) and length (e.g., the number of OFDM symbols) of the PDSCH in a slot.
PDSCH-to-HARQ_feedback timing indicator: Indicates K1.
HARQ process number (4 bits): Indicates HARQ process identify (ID) for data (e.g. PDSCH or TB)
PUCCH resource indicator (PRI): Indicates a PUCCH resource to be used for UCI transmission from among multiple PUCCH resources within a PUCCH resource set.

After receiving a PDSCH in slot #(n+K0) according to the scheduling information of slot #n, the UE may transmit UCI on a PUCCH in slot #(n+K1). The UCI includes an HARQ-ACK response to the PDSCH. In the case where the PDSCH is configured to carry one TB at maximum, the HARQ-ACK response may be configured in one bit. In the case where the PDSCH is configured to carry up to two TBs, the HARQ-ACK response may be configured in two bits if spatial bundling is not configured and in one bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

FIG. 5 illustrates an exemplary PUSCH transmission process.

Referring to FIG. 5, the UE may detect a PDCCH in slot #n. The PDCCH may include UL scheduling information (e.g., DCI format 0_0 or DCI format 0_1). DCI format 0_0 and DCI format 0_1 may include the following information.
Frequency domain resource assignment: Indicates an RB set allocated to a PUSCH.
Time domain resource assignment: Specifies a slot offset K2 indicating the starting position (e.g., symbol index) and length (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB. When a PUCCH transmission time and a PUSCH transmission time overlap, UCI may be transmitted through PUSCH (PUSCH piggyback).

### 1. DCI for Scheduling PDSCHs or PUSCHs on Multiple Serving Cells

The above contents are applicable in combination with methods proposed in the present disclosure, which will be described later. Alternatively, the contents may clarify the technical features of the methods proposed in the present disclosure.

In addition, the following methods may be equally applied to the above-described NR system or shared spectrum (licensed bands). Thus, it is obvious that the terms, expressions, and structures in this document may be modified to be suitable for the system in order to implement the technical idea of the present disclosure in the corresponding system.

In a CA situation in which a plurality of cells are configured, to reduce a DCI overhead required for PDSCH/PUSCH scheduling, a multi-cell scheduling (multi-CC scheduling) method for simultaneously scheduling a plurality of serving cells/CCs with single DCI (based on justification shown in Table 7) in Rel-18 may be considered. In this specification, the expression “scheduling a plurality of cells” may be understood as “scheduling a PDSCH or PUSCH to be transmitted in each of the plurality of cells.” In other words, multi-cell DCI means DCI for scheduling PDSCHs or PUSCHs on different cells through a single DCI.

Table 7 shows a justification for supporting DCI for this purpose in Rel-18 and may be understood as one of motivations for introducing such DCI (PDCCH).

Excerpt from RP-220834

NR supports a wide range of spectrum in different frequency ranges. It is expected
that there will be increasing availability of spectrum in the market for 5G Advanced possibly
due to re-farming from the bands originally used for previous cellular generation
networks. Especially for low frequency FRI bands, the available spectrum blocks tend to be
more fragmented and scattered with narrower bandwidth. For FR2 bands and some FRI
bands, the available spectrum can be wider such that intra-band multi-carrier operation is
necessary. To meet different spectrum needs, it is important to ensure that these scattered
spectrum bands or wider bandwidth spectrum can be utilized in a more spectral/power
efficient and flexible manner, thus providing higher throughput and decent coverage in the
network.
One motivation is to increase flexibility and spectral/power efficiency on scheduling
data over multiple cells including intra-band cells and inter-band cells. The current
scheduling mechanism only allows scheduling of single cell PUSCH/PDSCH per a
scheduling DCI. With more available scattered spectrum bands or wider bandwidth spectrum,
the need of simultaneous scheduling of multiple cells is expected to be increasing. To reduce
the control overhead, it is beneficial to extend from single-cell scheduling to multi-cell
PUSCH/PDSCH scheduling with a single scheduling DCI. Meanwhile, trade-off between
overhead saving and scheduling restriction has to be taken into account.

Accordingly, the present disclosure proposes a method of configuring and interpreting fields within DCI to design a structure of DCI for multi-cell scheduling (multi-cell DCI).

The number of cells that a multi-cell DCI schedules simultaneously is large, and thus when each field of the DCI is separately configured for each cell, a size of the DCI may increase significantly. Due to the characteristics of a polar code used for DCI encoding, the size of the DCI needs to be adjusted to be less than or equal to a certain number of bits (e.g., up to 140 bits). On the other hand, when each field of the corresponding DCI is configured commonly for all cells to be scheduled (common/shared configuration), the size of the DCI may be reduced, but scheduling flexibility may be significantly reduced. Therefore, depending on the characteristics of each DCI field, it is necessary to appropriately adjust separate configuration and common configuration for each scheduled cell.

For reference, the RRC parameter PDSCH-TimeDomainResourceAllocationList includes k0, mappingType, and startSymbolAndLength, and definition of each field is as shown in Table 8.

TABLE 8
PDSCH-TimeDomainResourceAllocation field descriptions
k0
Slot offset between DCI and its scheduled PDSCH (see TS 38.214 [19], clause
5.1.2.1). k0-v1710 is only applicable for PDSCH SCS of 480 kHz and 960 kHz. When the
field is absent the UE applies the value 0.
mappingType
PDSCH mapping type (see TS 38.214 [19], clause 5.3).
startSymbolAndLength
An index giving valid combinations of start symbol and length (jointly encoded) as
start and length indicator (SLIV). The network configures the field so that the allocation does
not cross the slot boundary (see TS 38.214 [19], clause 5.1.2.1).

When a time domain resource allocation (TDRA) field of multi-cell DCI is configured, one or more of the following methods may be applied.

### Method to be Applied to Each Field

### Method 1: Shared-Cell-Common

Method in which only one field is configured within multi-cell DCI, and a value indicated by the corresponding DCI field is commonly applied to all cells (scheduled through multi-cell DCI).

### Method 2: Shared-State-Extension

Method in which only one field is configured within multi-cell DCI, and each of multiple states to be indicated by the corresponding DCI field is configured/set by a combination of multiple pieces of information about multiple cells (not information about a single cell).

### Method 3: Separate

Method in which a number of fields (within the DCI) equal to the number of cells scheduled through multi-cell DCI (with an operation configured according to the corresponding DCI field instruction) is configured, a separate field corresponds to each of the scheduled cells, and a value indicated by the corresponding field is applied to the corresponding cell.

### Method 4: Shared-Reference-Cell

Method in which only one field is configured within multi-cell DCI, a value indicated by the corresponding DCI field is applied only to a specific reference cell (e.g., a cell to which the corresponding DCI is transmitted, a cell with the lowest or highest cell index, or a cell indicated by a CIF field value) (from among cells that are scheduled through multi-cell DCI and for which an operation is configured according to indication of the corresponding DCI field), and a specific default value predefined/configured is applied to the remaining cells.

The expression “cell” within the specification may be interpreted depending on the context. For example, a cell may mean a serving cell. The cell may include one DL component carrier (DL CC) and 0 to 2 UL CCs, but the methods described below are not limited thereto. In the expressions described below, cells and CC may be used interchangeably unless otherwise specified. The cells/CCs may be replaced with (active) BWPs within the serving cell and applied. Unless otherwise specified, in the methods described below, the cell/CC may be used as a concept encompassing primary cell (PCell), secondary cell (SCell), primary SCell (PS cell), and the like, which may be configured/expressed in a carrier aggregation (CA)/dual connectivity (DC) scenario.

In the specification, a (specific) reference cell may be determined/configured as a cell to which the corresponding DCI is transmitted, a cell with the lowest (or highest) cell index, or a cell indicated by a CIF field value from among cells scheduled via a single multi-cell DCI. Alternatively, the (specific) reference cell may be determined/configured as a cell to which the corresponding DCI is transmitted, a cell with the lowest (or highest) cell index, or a cell indicated by a CIF field value from among cells to be scheduled via single multi-cell DCI (i.e., not a cell scheduled at a specific time or with a specific control channel). Alternatively, the (specific) reference cell may be one specific cell configured through RRC signaling from among cells configured in a UE (or from among cells to be scheduled through multi-cell DCI).

When scheduling cells of multi-cell DCI (cells in which a UE monitors the multi-cell DCI) are different from each other, different reference cells may be configured. For example, in a scenario in which scheduling cells time-vary, reference cells may be separately configured for each scheduling cell. Alternatively, the reference cell may be (re)configured when the scheduling cell changes. When a scheduling cell changes, the reference cell may be (re)configured not only when a combination of cells scheduled via the corresponding multi-cell DCI changes but also when the combination does not change. Depending on a carrier type and/or SCS size of a scheduling cell (or scheduled cell(s)) for the multi-cell DCI, a reference cell for the multi-cell DCI may be (re)configured (or a reference cell may be separately configured for each carrier type and/or SCS size).

In the present disclosure, a reference cell may mean a cell with the lowest (or highest) cell index or a cell with the earliest (or latest) indicated PDSCH/PUSCH transmission starting symbol time within a combination of cells (co-scheduled cell set or each cell subgroup) that are simultaneously scheduled through the same multi-cell DCI. When there are multiple cells with the earliest (or latest) PDSCH/PUSCH starting symbol time, the cell with the lowest (or highest) cell index from among the corresponding multiple cells may be configured as the reference cell. Alternatively, the reference cell may be a cell with the earliest (or latest) indicated PDSCH/PUSCH transmission ending symbol time from among a combination of simultaneously scheduled cells. When there are multiple cells with the earliest (or latest) PDSCH/PUSCH ending symbol time, the cell with the lowest (or highest) cell index from among the corresponding multiple cells may be configured as the reference cell. Alternatively, the reference cell may mean a cell prespecified through a cell indicated by a CIF field value or RRC within the combination of the simultaneously scheduled cells. Alternatively, the reference cell may mean a cell with the lowest (or highest) cell index within a schedulable cell set of all cells schedulable via any multi-cell DCI, a cell indicated by a CIF field value, a cell to which multi-cell DCI is transmitted, or a cell previously designated via RRC.

In the case of a DCI field to which a shared-reference-cell method, a shared-cell-common method, and a shared-state-extension method proposed in the present disclosure are applied, only one field may be configured within multi-cell DCI (i.e., commonly applied to all cells belonging to the co-scheduled cell set). Alternatively, in a state in which all cells belonging to a set of simultaneously scheduled cells (a co-scheduled cell set) are grouped into one or more cell subgroups (which may be used interchangeably with “cell group”), one (commonly applied) DCI field may be configured for each cell subgroup (separate/independent fields may be configured between cell subgroups). Alternatively, in a state in which all cells belonging to a schedulable cell set may be grouped into one or more cell subgroups, one DCI field (commonly applied) may be configured for each cell subgroup (separate/independent fields may be configured between cell subgroups). Accordingly, a shared-reference-cell method, a shared-cell-common method, and a shared-state-extension method, and the configuration/instruction method of fields/information based thereon may be applied to each cell subgroup. Each cell subgroup may be configured/set up by a specific cell or a specific plurality of cells belonging to a set of simultaneously scheduled cells or a set of schedulable cells (e.g., some or all of the cells belonging to the co-scheduled cell set or the schedulable cell set).

In the conventional single-cell DCI-based scheduling, when a method of indicating to a UE and a BS for a specific DCI field (e.g., a TDRA field) uses a structure in which one of rows in a table is indicated through the corresponding DCI field while the table configured with one or more rows (including different parameters/values or a combination thereof) for each cell is preconfigured via RRC or MAC-CE, the shared-cell-common method for the field in the multi-cell DCI proposed in the present disclosure may operate based on one or more of the following three options. For reference, in the specification, the row may be replaced with a state, an index, and a codepoint. A cell set may refer to, for example, a schedulable cell set, a co-scheduled cell set, or a cell subgroup.

Option X: A specific state/index/codepoint indicated through a DCI field that is commonly configured for a cell set to which the shared-cell-common method is applied may be interpreted/applied by the UE as a parameter/value configured in a row corresponding to the corresponding state/index/codepoint in the (single-cell) table configured for each cell belonging to the corresponding cell set or a combination thereof (i.e., each for each cell).

Option Y: A specific state/index/codepoint indicated through a DCI field that is commonly configured for a cell set to which the shared-cell-common method is applied may be interpreted as a parameter/value or a combination thereof corresponding to the corresponding state/index/codepoint in a table configured for a specific reference cell in the corresponding cell set and may be commonly applied to cells belonging to the corresponding cell set.

Option Z: A specific state/index/codepoint indicated through a DCI field that is commonly configured for a cell set to which the shared-cell-common method is applied may be interpreted as a parameter/value or a combination thereof corresponding to the corresponding state/index/codepoint in a corresponding table and may be commonly applied to cells belonging to the corresponding cell set while a separate common table to be commonly applied to the corresponding cell set is preconfigured via RRC/MAC-CE.

When the option X method is applied to a specific DCI field (e.g., a TDRA field), the size of the corresponding DCI field in the multi-cell DCI may be determined based on the minimum L value or the maximum L value from among the L values of the corresponding multiple cells when the number of rows configured in the (single-cell) table configured for each of the multiple cells belonging to the cell set is N and the corresponding number of bits is L=ceil (log₂(N)).

Alternatively, when the option X method is applied to a specific DCI field (e.g., a TDRA field), the size of the corresponding DCI field in the multi-cell DCI may be determined based on an L value of a specific cell specified through a separate RRC configuration or an L value of a specific cell determined based on a specific rule (e.g., the lowest cell index) when the number of rows configured in the (single-cell) table configured for each of multiple cells belonging to a cell set is N and the corresponding number of bits is L=ceil (log₂(N)).

And/or, the number of states/indexes/code points (and a corresponding DCI field size) to be indicated through the corresponding DCI field in the multi-cell DCI may be determined based on the minimum N value or the maximum N value from among the N values of the corresponding multiple cells. Alternatively, the number of states/indexes/code points to be indicated through the corresponding DCI field in the multi-cell DCI may be determined based on the N value of a specific cell specified through a separate RRC configuration or the N value of a specific cell determined based on a specific rule (e.g., the lowest cell index).

Depending on a DCI field configuration method, some rows within the (single-cell) table configured for a specific cell may not be able to be scheduled/instructed through the corresponding field. The DCI field configuration method may be based on the minimum L value or the minimum N value. Some rows may be the highest indexed row in the table. Some of the rows indicated may be TDRA parameters including SLIV.

When a specific (e.g. highest) state/index/code point is indicated through the corresponding DCI field (for example, in the case of the method based on the maximum L value or maximum N value as described above), the corresponding row in the (single-cell) table configured in a specific cell may not be configured. In this case, the UE may perform transmission and reception operations assuming that there is no PDSCH/PUSCH scheduling for the corresponding cell. Alternatively, in this case, the UE may interpret/apply the indicated specific state/index/code point as a parameter/value corresponding to the largest value (or smallest value) from among the corresponding rows in the (single-cell) table configured for the corresponding cell, or a combination thereof. The corresponding row may be indicated by a TDRA parameter including SLIV

In more detail, the proposal is as follows.

First, in the existing single-cell DCI-based scheduling, when one of the corresponding N states/indexes is indicated through the corresponding DCI field while N (different) parameters/values or a combination thereof are configured to each of N states/indexes to be indicated by the DCI field via RRC or MAC-CE, the UE applies the parameter/value or a combination thereof configured for the indicated state/index (and performs a PDSCH/PUSCH transmission/reception operation therethrough). In this case, the size of the DCI field may be determined by ceil {log₂(N)} bits, and in this case, N may be configured to a different (or the same) value for each cell.

In the case of the specific DCI field in the multi-cell DCI-based scheduling, when a specific state/index is indicated through the DCI corresponding field in a state in which parameters/values or a combination thereof for each state/index (applicable to single-cell DCI-based scheduling) for each cell belonging to a cell set are preconfigured, the UE may interpret/apply the parameters/values or a combination thereof configured for each cell for the indicated state/index for each cell (and perform transmission and reception operations for the PDSCH/PUSCH scheduled for each cell therethrough).

In multi-cell DCI-based scheduling, the size of the TDRA field may be determined by one of the following three methods by using the maximum value N_max and the minimum value N_min from among the N values configured for each cell belonging to the corresponding set of the entire schedulable cells (or each co-scheduled cell set).

Alt-A) Determined by ceil {log₂(N_max)} bits based on the maximum value N_max (in this case, it may be a structure in which up to (the first) N_max states/indexes are indicated through the DCI field)

Alt-B) Determined by ceil {log₂(N_max)} bits based on the minimum value N_min (in this case, it may be a structure in which only (first) N_min states/indexes are indicated through the DCI field)

Alt-C) Determined by ceil {log₂(N_max)} bits based on a specific value (=N_exp) configured separately (in this case, it may be a structure in which only (first) N_exp states/indexes are indicated through the DCI field)

In this case, N_exp may be configured (via RRC) to a value in the range of [N_min, N_max] or implicitly determined by a separate rule.

When the Alt-A method or the Alt-C method is applied, if a specific state/index (e.g., a state/index higher than {N_low−1}) is indicated through the TDRA field for a specific cell (e.g., cell X in which N is configured to N_low, which is a value less than N_max), the parameter/value or combination thereof configured for the corresponding state/index may not exist for the cell X. In consideration of these cases, the following operations are proposed. For convenience, M=ceil {log₂(N_max)} and K=ceil {log₂(N_low)}(M≥K) are defined. Additionally, in the description below, values of the DCI fields corresponding to N states/indexes are assumed to be 0, . . . , N−1.

Alt 1: For the above cell X, only the K bits starting from the MSB or the K bits starting from the LSB (LSB) from among the M bits in the DCI field are interpreted and applied.

A. For example, for two co-scheduled cells, cell #1 and cell #2, the states/indexes to be indicated through the TDRA field may be configured to N1 and N2, respectively. From among the ceil {log₂(N_max)} bits of the TDRA field, a specific state/index is indicated using only ceil {log₂(N1)} bits from the MSB (or LSB) for cell #1 and only ceil {log₂(N2)} bits from the MSB (or LSB) for cell #2. Parameters/values configured for the TDRA row index corresponding to the indicated TDRA state/index (defined/set for each cell) or a combination of these, i.e. {K0/K2, SLIV, and mapping type} may be applied to each cell.

B. When a state/index with a value higher than {N_low−1} is indicated through the K bits, an operation of another Alt (e.g., Alt 3 or Alt 6) below may be applied.

Alt 2: When a state/index higher than {N_low−1} is indicated through the DCI field, a specific parameter/value or a combination thereof preconfigured separately for the cell X may be applied.

A. The specific parameter/value or combination thereof may be configured/defined as a parameter/value or combination thereof connected to a specific one (e.g. lowest or highest) value from among the N_low states/indexes preconfigured for the cell X.

B. For example, for two co-scheduled cells, cell #1 and cell #2, the states/indexes to be indicated through the TDRA field may be configured to N1 and N2, respectively. If N1>N2, N_max is N1. When the TDRA field is indicated to a specific state/index value between {0, . . . , N2-1} via the ceil {log₂(N1)} bits, the parameter/value configured for the TDRA row index corresponding to the TDRA state/index defined/configured in the cell #2 or a combination thereof (K0/K2, SLIV, and mapping type) may be applied without change. When the TDRA field is indicated by the ceil {log₂(N1)} bits to a value greater than or equal to N2, a one specific value from among the parameters/values configured in the TDRA row index corresponding to the (N2) TDRA states/indexes configured in cell #2, or a combination thereof, may be applied.

Alt 3: When a state/index with a value higher than {N_low−1} is indicated through the DCI field, it is considered that there is no PDSCH/PUSCH scheduling for the cell X.

A. Accordingly, the UE may omit PDSCH/PUSCH transmission and reception operations on the corresponding cell X (in the case of PDSCH, the corresponding HARQ-ACK is fed back as NACK).

B. For example, for two co-scheduled cells, cell #1 and cell #2, the states/indexes to be indicated through the TDRA field may be configured to N1 and N2, respectively. If N1>N2, N_max is N1. When the TDRA field is indicated to a specific state/index value between {0, . . . , N2-1} via the ceil {log₂(N1)} bits, the parameter/value configured for the TDRA row index corresponding to the TDRA state/index defined/configured in the cell #2 or a combination thereof may be applied without change. When a value greater than or equal to N2 is indicated through ceil {log₂(N1)} bits, TDRA indication ({K0/K2, SLIV, and mapping type}) for cell #2 may be considered as non-existent (or there may be no PDSCH/PUSCH scheduling for the cell #2).

Alt 4: For the cell X, {N_max−N_low}=N_gap parameters/values or a combination thereof corresponding to each state/index from N_low to N_max−1 are additionally configured.

A. The additional parameters/values or a combination thereof may be configured to parameters/values or a combination thereof connected to specific N_gap states/indexes from among the N_low states/indexes preconfigured for the cell X.

B. For example, for two co-scheduled cells, cell #1 and cell #2, the states/indexes to be indicated through the TDRA field may be configured to N1 and N2, respectively. If N1>N2, N_max is N1. When the TDRA field is indicated to a specific state/index value between {0, . . . , N2-1} via the ceil {log₂(N1)} bits, the parameter/value configured for the TDRA row index corresponding to the TDRA state/index defined/configured in the cell #2 or a combination thereof is applied without change. When the TDRA field is indicated as a value greater than or equal to N2 via the ceil {log₂(N1)} bits, separately (additionally) configured parameters/values or a combination thereof may be applied.

Alt 5: For cell X, the state/index indicated by the DCI field may be interpreted and applied as the state/index corresponding to the value obtained by performing modulo-N_low operation.

A. For example, when N_low=5 and N_max=8, each state/index {0,1,2,3,4,5,6,7} indicated by the DCI field may be interpreted/applied as state/index {0,1,2,3,4,0,1,2} for the cell X, respectively.

Alt 6: When a state/index with a value higher than {N_low−1} is indicated through the DCI field, the most recently indicated state/index for cell X may be applied/maintained.

A. Accordingly, the UE may perform PDSCH/PUSCH transmission and reception operations on cell X by applying/maintaining the recently instructed state/index to cell X.

When the option X method is applied to the TDRA field, the K0 (and/or K2) values configured in the (single-cell) table of a specific reference cell from among multiple cells belonging to the cell set may be exceptionally and commonly applied to the multiple cells. In this case, the UE may disregard and not apply the K0 (and/or K2) values configured in the (single-cell) table of cells other than the reference cell. This may reduce the complexity when a specific (e.g. Type-1) HARQ-ACK codebook is configured.

The reference cell may be determined as a specific cell determined based on a specific rule (for example, the lowest cell index) from among the corresponding plurality of cells, a specific cell designated through a separate RRC configuration, a specific cell corresponding to the L value (or N value) that determines the TDRA field size (or the number of states/indexes/codepoints to be indicated through the field), or a specific cell configured with the lowest or largest K0 (and/or K2) value from among the co-scheduled cells.

Alternatively, when the option X method is (equally) applied to the TDRA field, slot positions in which the PDSCHs (occasions) on the co-scheduled cells are actually transmitted may be determined such that the (last) PDSCHs (occasions) on all the co-scheduled cells are included in the slot containing the latest PDSCH (occasion) from among the PDSCHs scheduled/instructed to the co-scheduled cells (in consideration of the situation in which slot aggregation transmission is configured for some of the co-scheduled cells).

### 1.1 Method of Configuring TDRA Field of UL (or DL) DCI for Multi-Cell PUSCH (or PDSCH) Scheduling

This section describes a method of configuring a TDRA field to be included in the DCI to design a multi-cell DCI structure. Multi-cell PUSCH refers to PUSCHs scheduled on different cells, and multi-cell PUSCH scheduling refers to an operation of scheduling PUSCHs on different cells. Multi-cell PDSCH refers to PDSCHs scheduled on different cells, and multi-cell PDSCH scheduling refers to an operation of scheduling PDSCHs on different cells.

The TDRA field of the multi-cell DCI may be configured in one of the following options based on the method applicable to each field described above.

### 1.1-1 Opt 1: Application of the Shared-State-Extension Method

Each of the multiple states to be indicated by the corresponding DCI field may be configured/set by a combination of multiple TDRA field values for multiple PDSCHs or PUSCHs on multiple cells (not TDRA field values for PDSCHs or PUSCHs on a single cell). Accordingly, a combination of specific TDRA values (for multiple PDSCHs (or PUSCHs) on multiple cells) may be indicated through the value of one field.
Embodiment 1: A TDRA table for distinguishing and indicating all combinations of cells to be scheduled with multi-cell DCI is predefined/configured. Each cell combination may be indicated by a row index (or codepoint) in the TDRA table. In this case, the TDRA field value may be the row index of the corresponding TDRA table. As the number of cells to be scheduled increases, the size of the corresponding TDRA table may increase. The number of bits in the TDRA field may also be determined by the size of the TDRA table. In this case, the TDRA table may be configured/reconfigured using RRC or MAC-CE.
Embodiment 2: The field may be configured and operated in the same manner as [Embodiment 1]. However, even if the number of cells to be scheduled increases, the size of the TDRA table (or number of rows) and the number of bits in the TDRA field may be maintained at a specific value. To this end, as the number of cells to be scheduled increases, only some of the combinations of cells to be scheduled may be indicated by the TDRA table and TDRA field. According to Embodiment 2, the size of the TDRA field is reduced compared to Embodiment 1, and thus the DCI overhead is also reduced, but scheduling flexibility may also be reduced.
Embodiment 3: After a combination of cells (or cell group) to which one TDRA field value is applied is predefined/configured, one TDRA table is defined/configured for each cell group. The row index of the corresponding TDRA table may be indicated to the UE. In this case, multiple cell groups may be defined/configured. The size of the TDRA table for a cell group may vary depending on the number of cells in the cell group. The number of bits in the TDRA field may be determined based on the cell group scheduled via multi-cell DCI (or based on the row of the corresponding table). The cell group and/or the TDRA table may be configured/reconfigured using RRC or MAC-CE.
In detail, only one TDRA field may be configured for multiple cells scheduled through one multi-cell DCI. In a state in which N pieces of TDRA information (corresponding to the N cells) are configured for each state to be indicated by the corresponding TDRA field, multiple pieces of TRDA information (for each cell) corresponding to the state indicated through the corresponding TDRA field may be separately applied to the multiple cells. The TDRA information may include, for example, N combinations of {K0 value or K2 value, PDSCH or PUSCH mapping type, PDSCH or PUSCH time resource (SLIV)} corresponding to each cell.
A group of cells to which one (shared) TDRA field (multiple cell-specific TDRA information configured for each state indicated by this) is to be applied may be preconfigured based on the shared-state-extension method. Accordingly, for each cell group scheduled via multi-cell DCI, shared TDRA fields/information according to the proposal may be configured/indicated.
In another method, when multiple TDRA information corresponding to multiple cells are configured for each state to be indicated through the shared TDRA field, only one value of K0 or K2 may be configured (without being configured separately for each cell). The UE may determine a PDSCH/PUSCH transmission (reference) slot on a specific reference cell by applying the corresponding one K0/K2 value to the corresponding reference cell and determine a PDSCH/PUSCH transmission slot on the remaining (other) cells based on the corresponding reference slot. For example, the PDSCH/PUSCH transmission slot on the remaining cells may be determined as a first (or last) slot that overlaps in time with the reference slot.

For a K1 field indicating a slot offset from the PDSCH transmission slot to the HARQ-ACK transmission slot, only one field may be configured for multiple cells scheduled via multi-cell DCI. The UE may determine a HARQ-ACK transmission (reference) slot corresponding to PDSCH transmission/reception on a specific reference cell by applying one K1 value indicated through the field to the specific reference cell and may also determine the reference slot as a HARQ-ACK transmission slot for PDSCH transmission/reception on the remaining cells (equally). A specific reference cell may be a cell containing a specific PDSCH. The specific PDSCH may be, for example, a PDSCH with the earliest transmission start time/symbol or the PDSCH with the latest transmission end time/symbol.

### 1.1-2 Opt 2: Application of the Shared-Cell Common Method

A value indicated by the DCI field may be commonly applied to the PDSCH (or PUSCH) on all cells (scheduled via multi-cell DCI).
Embodiment 1: A combination of cells (or cell group) to which one TDRA field value is applied is predefined/configured. Instructions to each cell within each cell group may be perform via the same TDRA field value. In this case, multiple cell groups may be defined/configured. The number of bits in the TDRA field may be determined depending on the group of cells scheduled as multi-cell DCI. The cell group may be configured/reconfigured using RRC or MAC-CE.
In detail, for multiple cells scheduled through one multi-cell DCI, only one TDRA field may be configured, and in a state in which only one TDRA information is configured for each state to be indicated by the TDRA field, one TDRA information corresponding to the state indicated through the TDRA field may be commonly applied to all of the multiple cells. The TDRA information may include, for example, combinations of {one K0 value or K2 value, one PDSCH or PUSCH mapping type, one PDSCH or PUSCH time resource (SLIV)}.
Based on the shared-cell-common method, a cell group to which one (shared) TDRA field (one TDRA information configured for each state indicated by this) is to be commonly applied may be preconfigured, and accordingly, a shared TDRA field/information according to the proposal may be configured/indicated for each cell group scheduled through multi-cell DCI.
When invalid SLIV information is configured/indicated for a specific cell belonging to a specific cell group scheduled via multi-cell DCI (in which the same single shared TDRA field/information may be configured/indicated), the following operations may be performed:

Alt 1: It may be considered that a PDSCH (or PUSCH) is not scheduled for the corresponding cell, and PDSCH/PUSCH transmission and reception may be performed by applying the configured/indicated TDRA field value to the remaining cells scheduled simultaneously with the corresponding cell (or the remaining cells belonging to the same cell group as the corresponding cell).

Alt 2: The operation may be performed in a state in which the PDSCH (or PUSCH) is considered not to be scheduled for all cells in the cell group to which the cell belongs.

### 1.1-3 Opt 3: Application of the Separate Method

A separate field may be configured for each cell scheduled via multi-cell DCI. The size of each separate field may vary depending on the number of cells scheduled. For example, the separate field size may be configured to be less when the number of scheduled cells exceeds N (e.g. N=1) than when the number of scheduled cells is N or less.
Embodiment 1: The TDRA field value may be configured for each scheduled cell. The number of bits in the corresponding TDRA field may be determined depending on the number of cells to be scheduled. The TDRA field size for each cell may be fixed or variable, regardless of the number of cells to be scheduled. For example, as the number of cells to be scheduled increases, the size of the corresponding field may be proportionally reduced (e.g. reducing the size of the TDRA table). Alternatively, an upper limit on the number of cells scheduled simultaneously may be defined/configured (to keep the number of bits below a certain level).
Embodiment 2: A TDRA table may be configured for each cell, and an index of the TDRA table for each cell may be indicated to the UE. The number of bits in the corresponding TDRA field may be determined depending on the size of the corresponding TDRA table and the number of TDRA tables (i.e., the number of cells to be scheduled). The size of the TDRA table for each cell may be adjusted depending on the number of cells. For example, the size of the TDRA table may be changed proportionally to the number of CCs. As another example, one of two sizes may be determined as the size of the TDRA table depending on whether the number of cells to be scheduled is 1 or 2 or more.
Embodiment 3: After a combination of cells (or cell groups) to have the same number of bits in the TDRA field is predefined/configured, a separate TDRA field may be configured for each cell group. In this case, multiple cell groups may be defined/configured. The size of the TDRA table for the corresponding cell group may vary depending on the number of cells in the cell group. The cell group and/or the TDRA table may be configured/reconfigured using RRC or MAC-CE.
Embodiment 4: From among the cells scheduled through multi-cell DCI, when the TDRA field is configured for some cells and not configured for other cells, the TDRA field value of a specific cell from among the “cells with TDRA set” may be applied based on the position of the PDSCH (or PUSCH) reception/transmission slot (or symbol) of the “some cells with no TDRA set.” In this case, the specific cell may be a cell with the lowest (or highest) index, a scheduling cell, or a separately configured cell.
In detail, a separate TDRA field may be configured for each of cells scheduled through multi-cell DCI. The size of each separate field may vary depending on the number of cells scheduled. For example, the separate field size may be configured to be less when the number of scheduled cells exceeds N (e.g. N=1) than when the number of scheduled cells is N or less.
For example, when only one specific cell is scheduled through multi-cell DCI for a specific cell, a TDRA field of K bits is configured and TDRA information configured to one of M states is indicated through the field. On the other hand, in case multiple cells (including the cell) are scheduled via multi-cell DCI, the TDRA field corresponding to each cell may be configured with only L bits (L<K), and in this case, TDRA information configured to one of H (H<M) states (for the corresponding cell) may be indicated.
In this case, the H states may be configured to specific H states from among the M states. For example, from among M TDRA (state) indices, H indices in low order (or high order) may be configured to H states.

### 1.1-4 Opt 4: Application of the Shared-Cell-Common Method and Separate Method

Some of the values indicated by the TDRA field may be commonly applied to the PDSCH (or PUSCH) on all cells (scheduled via multi-cell DCI) according to the shared-cell-common method. In some other cases, separate fields may be configured for each scheduled cell according to the separate method.
Embodiment 1: From among K0 and SLIV to be conventionally indicated by TDRA, a shared-cell-common method may be applied to one, and a separate method may be applied to the other. For example, for cells to which the corresponding TDRA field value is applied, scheduled PDSCHs (or PUSCHs) may have SLIV values separately configured for each cell while having the same K0 (or K2) value. Alternatively, for cells to which the corresponding TDRA field is applied, scheduled PDSCHs (or PUSCHs) may have K0 (or K2) value separately configured for each cell while having the same SLIV value.

### 1.1-5 Opt 5: Application of the Shared-Reference-Cell Method

The TDRA field is transmitted/applied only to the PDSCH (or PUSCH) on a specific reference cell (from among cells scheduled via multi-cell DCI). The UE may operate assuming that there is no TDRA field for the PDSCH (or PUSCH) on the remaining cells (depending on a value of the TDRA field on the corresponding specific reference cell). In this case, the reference cell may be predefined or configured.
Embodiment 1: When K0 and/or K2 values are configured for a specific reference cell and not configured for other cells, the transmission/reception slots of the PDSCH or PUSCH of the “other cells” may be determined using the K0 and/or K2 values configured for the reference cell.
When an invalid SLIV is configured/indicated for a specific cell scheduled via multi-cell DCI (or belonging to the same cell group to be configured with one TDRA field value), the following operation may be performed.
Alt 1: When an invalid SLIV is configured/indicated for the reference cell, the UE considers that a PDSCH (or PUSCH) is not scheduled for the reference cell and does not apply the configured TDRA field value. The TDRA field value configured in the reference cell may be applied to the remaining cells scheduled simultaneously with the corresponding cell (or the remaining cells belonging to the same cell group as the corresponding cell).
Alt 2: When an invalid SLIV is configured/indicated for the reference cell, the UE considers that a PDSCH (or PUSCH) is not scheduled for all cells scheduled simultaneously with the reference cell (or belonging to the same cell group as the reference cell), and does not apply the configured TDRA field value.
Alt 3: When an invalid SLIV is configured/indicated for the remaining cells other than the reference cell, the UE considers that a PDSCH (or PUSCH) is not scheduled for the corresponding remaining cells and does not configure/apply the corresponding TDRA field value. For the remaining cells, the same configured TDRA field value may be applied.

When the PDSCH (or PUSCH) SLIV resource of a specific cell indicated through multi-cell DCI overlaps a specific (e.g., semi-static) UL/DL symbol, the UE may operate to drop or rate-match the PDSCH (or PUSCH) of the corresponding cell.

In addition, (for example, with respect to the shared-state-extension method) when a TDRA table is configured/defined for the entire schedulable cell set (all cells belonging thereto) to be scheduled via multi-cell DCI, and a specific co-scheduled cell set is indicated via a specific (e.g. CIF) field configured/set in the multi-cell DCI, the UE may perform PDSCH/PUSCH transmission/reception (for each cell) while considering/assuming that only SLIVs corresponding to each cell belonging to the co-scheduled cell set are valid. Therefore, SLIVs corresponding to cells that do not belong to the indicated co-scheduled cell set may be considered/assumed to be invalid.

The contents of the present disclosure are not limitedly applied only to UL and/or DL signal transmission and reception. For example, the contents of the present disclosure may also be used for direct communication between UEs. In this document, the term based station (BS) may be understood as a concept including a relay node as well as a BS. For example, the operations of a BS described in the present disclosure may be performed by a relay node as well as the BS.

It is obvious that each of the examples of the proposed methods may also be included as one implementation method of the present disclosure, and thus each example may be regarded as a kind of proposed method. Although the above-described proposed methods may be implemented independently, some of the proposed methods may be combined and implemented. In addition, it may be regulated that information on whether the proposed methods are applied (or information on rules related to the proposed methods) is transmitted from the BS to the UE in a predefined signal (e.g., physical layer signaling or higher layer signaling).

### Implementation Examples

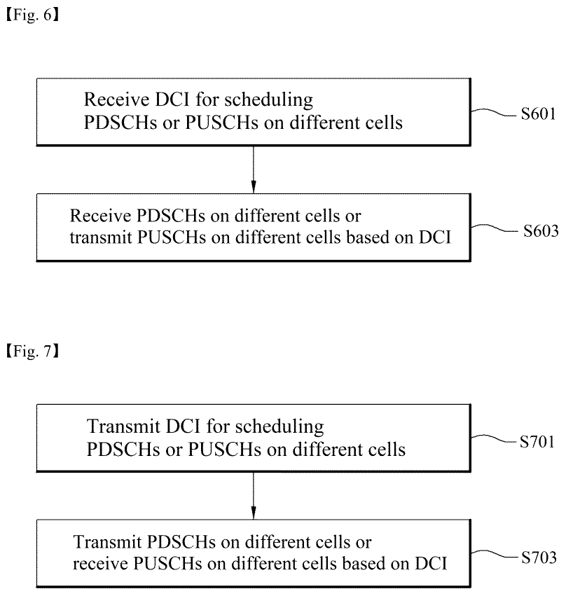

FIGS. 6 and 7 are flowcharts of a signal transmission and reception method according to an embodiment of the present disclosure.

Referring to FIG. 6, the method according to an embodiment of the present disclosure may be performed by a UE and may include receiving DCI for scheduling PDSCHs or PUSCHs on different cells (S601) and receiving the PDSCHs on the different cells or transmitting the PUSCHs on the different cells based on the DCI (S603).

Referring to FIG. 7, the method according to another embodiment of the present disclosure may be performed by a BS and may include transmitting DCI for scheduling PDSCHs or PUSCHs on different cells (S701) and transmitting the PDSCHs on the different cells or receiving the PUSCHs on the different cells based on the DCI (S703).

In addition to the operations of FIGS. 6 and/or 7, one or more of the operations described through Section 1 may be additionally performed.

In detail, referring to 1.1, DCI for scheduling PDSCHs or PUSCHs on different cells may be referred to as multi-cell DCI. Multi-cell DCI contains one or more TDRA fields for PDSCHs or PUSCHs on different cells. In a multi-cell DCI architecture, the TDRA field may include a combination of one or more of Opt 1 to 5 of Section 1.1.

According to Opt 1, the shared-state-extension method is applied. Therefore, the DCI includes one TDRA field for the PDSCHs or the PUSCHs. A TDRA field indicates a row index in the TDRA table for PDSCHs or PUSCHs on different cells.

Here, according to Embodiment 1 of Opt 1, one TDRA field uniquely indicates all combinations of cells to be scheduled with multi-cell DCI, and thus each row of the TDRA table includes information about all combinations of different cells.

According to Embodiment 2 of Opt 1, the size of the TDRA table and the number of bits of the TDRA field are kept constant, and thus each row of the TDRA table contains information about a combination of some of the different cells.

According to Embodiment 3 of Opt 1, a cell group related to one TDRA field value is preconfigured, and thus each row of the TDRA table includes information about different cells belonging to one cell group.

Cell groups may be preconfigured. One TDRA field within DCI indicates the row index in the TDRA table for one cell group. The TDRA table used for a specific cell group may vary depending on the number of cells belonging to the corresponding cell group.

According to Opt 1, an interval K0 from a reception slot of DCI to a reception slot of PDSCHs or an interval K2 from a reception slot of DCI to a transmission slot of PUSCHs is not separately configured for each cell, and only one value may be configured. Accordingly, an interval from a reception slot of DCI to a reception slot of PDSCHs or a transmission slot of PUSCHs may be configured equally for PDSCHs or PUSCHs by the TDRA field.

According to Opt 2, the shared-cell-common method is applied. According to Opt 2, a value indicated by one TDRA field is commonly applied to PDSCHs or PUSCHs on all cells. Therefore, DCI includes one TDRA field for PDSCHs or PUSCHs, and one TDRA field indicates one value that is commonly applied to PDSCHs or PUSCHs.

According to Opt 3, the separate method is applied. According to Opt 3, separate fields are configured for PDSCHs or PUSCHs on different cells scheduled by one DCI. Therefore, the DCI contains a number of TDRA fields equal to the number of PDSCHs or PUSCHs, each of which indicates a value for a corresponding PDSCH or PUSCH.

According to Opt 4, the shared-cell-common method and the separate method are applied together. According to Opt 4, one of the values connected to the TDRA field is subject to the shared-cell common method, and the other is subject to the separate method. Therefore, the DCI includes a TDRA field including one first DCI field and a number of second DCI fields equal to the number of PDSCHs or the number of PUSCHs. When the first DCI field indicates a K0 or K2 value, the second DCI fields indicate a SLIV value. When the first DCI field indicates a SLIV value, the second DCI fields indicate a K0 or K2 value.

According to Opt 5, the shared-reference-cell method is applied together. According to Opt 5, the TDRA field is applied only to the PDSCH or the PUSCH on the reference cell. Therefore, the DCI contains one TDRA field for the PDSCH or the PUSCH on a reference cell from among the different cells.

In addition to the operations described with respect to FIGS. 6 and 7, one or more of the operations described with respect to FIGS. 1 to 5 and/or the operations described in Section 1 may be additionally performed in combination.

Example of Communication System to which the Present Disclosure is Applied

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

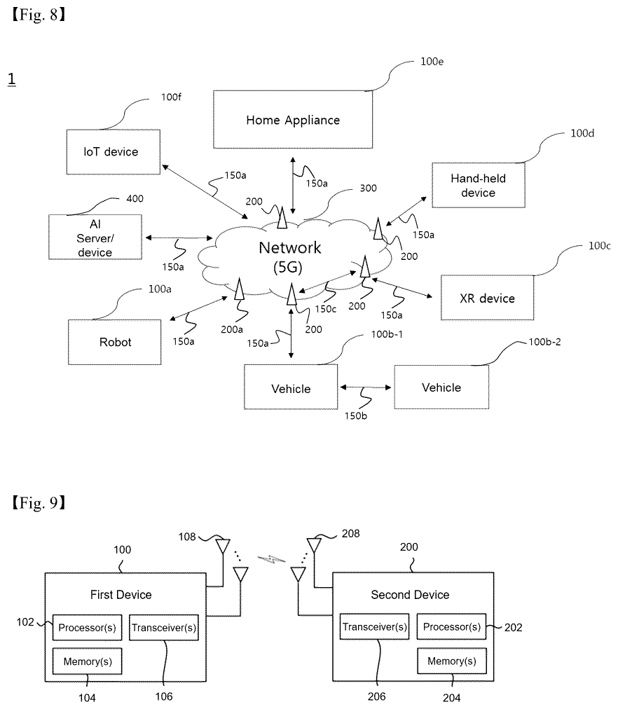

FIG. 8 illustrates a communication system 1 applied to the present disclosure.

Referring to FIG. 8, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

Example of Wireless Device to which the Present Disclosure is Applied

FIG. 9 illustrates wireless devices applicable to the present disclosure.

Referring to FIG. 9, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 8.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

Example of Use of Wireless Device to which the Present Disclosure is Applied

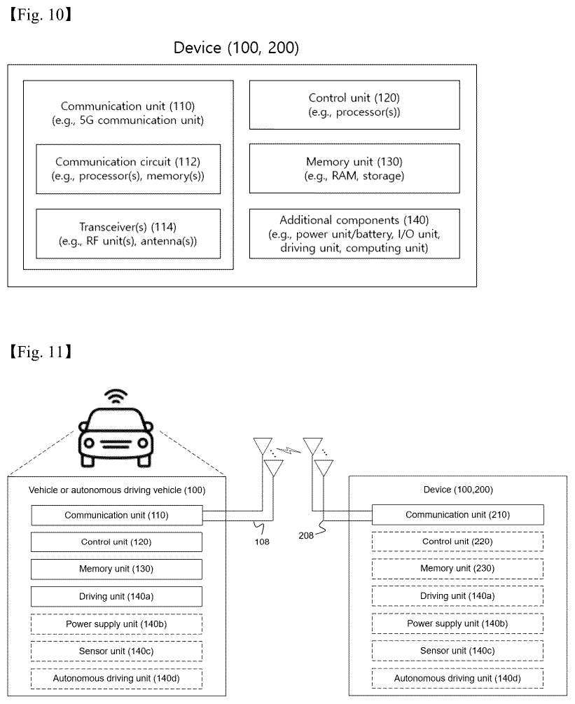

FIG. 10 illustrates another example of a wireless device applied to the present disclosure. The wireless device may be implemented in various forms according to a use case/service (refer to FIG. 8).

Referring to FIG. 10, wireless devices 100 and 200 may correspond to the wireless devices 100 and 200 of FIG. 9 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 9. For example, the transceiver(s) 114 may include the one or more transceivers 106 and 206 and/or the one or more antennas 108 and 208 of FIG. 9. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 8), the vehicles (100b-1 and 100b-2 of FIG. 8), the XR device (100c of FIG. 8), the hand-held device (100d of FIG. 8), the home appliance (100e of FIG. 8), the IoT device (100f of FIG. 8), a digital broadcasting terminal, a hologram device, a public safety device, an MTC device, a medical device, a FinTech device (or a finance device), a security device, a climate/environment device, the AI server/device (400 of FIG. 8), the BSs (200 of FIG. 8), a network node, or the like. The wireless device may be mobile or fixed according to a use case/service.

In FIG. 10, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

Example of Vehicle or Autonomous Driving Vehicle to which the Present Disclosure is Applied

FIG. 11 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 11, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 10, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

As described above, the present disclosure is applicable to various wireless communication systems.

1. A method of transmitting and receiving a signal by a user equipment (UE) in a wireless communication system, the method comprising:
receiving downlink control information (DCI) for scheduling physical downlink shared channels (PDSCHs) or physical uplink shared channels (PUSCHs) on different cells; and
receiving the PDSCHs on the different cells or transmitting the PUSCHs on the different cells based on the DCI,
wherein the DCI includes one or more time domain resource assignment (TDRA) for the PDSCHs or the PUSCH on the different cells.

2. The method of claim 1, wherein the DCI includes one TDRA field for the PDSCHs or the PUSCHs,
the one TDRA field indicates a row index in a TDRA table for the PDSCHs or the PUSCHs on the different cells, and
each row of the TDRA table includes information about a combination of all of the cells.

3. The method of claim 1, wherein the DCI includes one TDRA field for the PDSCHs or the PUSCHs,
the one TDRA field indicates a row index in a TDRA table for the PDSCHs or the PUSCHs, and
each row of the TDRA table includes information about a combination of some of the cells.

4. The method of claim 1, wherein the DCI includes one TDRA field for the PDSCHs or the PUSCHs,
the one TDRA field indicates a row index in a TDRA table for the PDSCHs or the PUSCHs, and
each row of the TDRA table includes information about a combination of cells belonging to one cell group.

5. The method of claim 4, wherein the cell group includes cells in which the PDSCHs or the PUSCHs indicated by the one TDRA field are transmitted.

6. The method of claim 1, wherein an interval from a reception slot of the DCI to a reception slot of the PDSCHs or a transmission slot of the PUSCHs is equally configured for the PDSCHs or the PUSCHs.

7. The method of claim 1, wherein the DCI includes one TDRA field for the PDSCHs or the PUSCHs, and
the one TDRA field indicates one value that is commonly applied to the PDSCHs or the PUSCHs.

8. The method of claim 1, wherein the DCI includes a number of TDRA fields, equal to a number of the PDSCHs or a number of the PUSCHs, and
each of the TDRA fields indicates a value for a corresponding PDSCH or PUSCH.

9. The method of claim 1, wherein the DCI includes a TDRA field including one first DCI field and a number of second DCI fields, equal to a number of the PDSCHs or a number of the PUSCHs,
an interval from a reception slot of the DCI to a transmission slot of the PDSCHs or a reception slot of the PUSCHs is equally configured through the first DCI field, and
each of the second DCI fields indicates a start symbol and symbol length of a corresponding PDSCH or PUSCH.

10. The method of claim 1, wherein the DCI includes a TDRA field including one first DCI field and a number of second DCI fields, equal to a number of the PDSCHs or a number of the PUSCHs,
a start symbol and symbol length of the PDSCHs or the PUSCHs are equally configured through the first DCI field, and
each of the second DCI fields indicates a transmission slot of a corresponding PDSCH or a reception slot of a PUSCH from a reception slot of the DCI.

11. The method of claim 1, wherein the DCI includes one TDRA field for the PDSCH or the PUSCH on a reference cell from among the different cells.

12. A user equipment (UE) for transmitting and receiving a signal in a wireless communication system, the UE comprising:
at least one transceiver;
at least one processor; and
at least one computer memory operatively connected to the at least one processor and configured to store instructions that when executed cause the at least one processor to perform a specific operation including:
receiving downlink control information (DCI) for scheduling physical downlink shared channels (PDSCHs) or physical uplink shared channels (PUSCHs) on different cells; and
receiving the PDSCHs on the different cells or transmitting the PUSCHs on the different cells based on the DCI,
wherein the DCI includes one or more time domain resource assignment (TDRA) for the PDSCHs or the PUSCH on the different cells.

13-15. (canceled)

16. A base station (BS) for transmitting and receiving a signal in a wireless communication system, the BS comprising:
at least one transceiver;
at least one processor; and
at least one computer memory operatively connected to the at least one processor and configured to store instructions that when executed cause the at least one processor to perform a specific operation including:
transmitting downlink control information (DCI) for scheduling physical downlink shared channels (PDSCHs) or physical uplink shared channels (PUSCHs) on different cells; and
transmitting the PDSCHs on the different cells or receiving the PUSCHs on the different cells based on the DCI,
wherein the DCI includes one or more time domain resource assignment (TDRA) for the PDSCHs or the PUSCH on the different cells.
